(19) United States
(12) Patent Application Publication
(10) Pub. No.: US 2019/0389385 A1
(43) Pub. Date: Dec. 26, 2019

(54) OVERLAY INTERFACES FOR REARVIEW MIRROR DISPLAYS

(71) Applicant: Ford Global Technologies, LLC, Dearborn, MI (US)

(72) Inventors: Jonathan Diedrich, Carleton, MI (US); Anthony Mark Phillips, Northville, MI (US); Brian Bennie, Sterling Heights, MI (US)

(21) Appl. No.: 16/017,777

(22) Filed: Jun. 25, 2018

(51) Int. Cl. B60R 1/12; B60R 1/04; G05D 1/02; H04N 7/18; G06K 9/00; G08G 1/16

(52) U.S. Cl. CPC B60R 1/12; B60R 1/04; G05D 1/0214; H04N 7/185; G06K 9/00798; B60R 2300/8093; G08G 1/167; B60R 2001/1215; B60R 2300/804; B60R 2300/8026; G06K 9/00805

(57) ABSTRACT

Method and apparatus are disclosed for overlay interfaces for rearview mirror displays. An example vehicle includes a front-view camera to capture a front-view image, a rearview camera to capture a rearview image, and a controller. The controller is configured to determine lane line projections and vehicle-width projections based on the front-view image and generate an overlay interface by overlaying the lane line projections and the vehicle-width projections onto the rearview image. The example vehicle also includes a rearview mirror display to present the overlay interface.

### TECHNICAL FIELD

The present disclosure generally relates to rearview mirror displays and, more specifically, to overlay interfaces for rearview mirror displays.

### BACKGROUND

Generally, a vehicle includes mirrors to facilitate a driver in viewing a surrounding area of the vehicle. Oftentimes, a vehicle includes a rearview mirror that is coupled a windshield of the vehicle and facilitates a driver in viewing an area behind the vehicle. A vehicle also oftentimes includes side-view mirrors (also known as side mirrors, wing mirrors, fender mirrors) that are coupled to corresponding doors of the vehicle and facilitate a driver in viewing an area to the side of and/or behind the vehicle. Typically, each rearview and side-view mirror of a vehicle includes a reflective layer (e.g., formed of metallic material) that enables a driver to view an area to the side of and/or behind the vehicle via the mirror. Recently, some vehicles have implemented a rearview mirror display that provide image(s) and/or video captured by a vehicle camera of an area behind the vehicle.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for overlay interfaces for rearview mirror displays. An example disclosed vehicle includes a front-view camera to capture a front-view image, a rearview camera to capture a rearview image, and a controller. The controller is configured to determine lane line projections and vehicle-width projections based on the front-view image and generate an overlay interface by overlaying the lane line projections and the vehicle-width projections onto the rearview image. The example disclosed vehicle also includes a rearview mirror display to present the overlay interface.

In some examples, the controller is configured to determine the lane line projections and the vehicle-width projections further based on the rearview image. Some such examples further include side-view cameras configured to capture side-view images. The controller is configured to determine the lane line projections and the vehicle-width projections further based on the side-view images.

In some examples, the lane line projections of the overlay interface facilitate a user in identifying lane lines of a road via the rearview mirror display when the rearview image is captured in a low-light environment. In some such examples, a position of the vehicle-width projections relative to the lane line projections facilitates the user in identifying a relative location of a nearby object. Further, in some such examples, the controller is configured to emit a lane-departure warning when one of the vehicle-width projections crosses a predetermined threshold corresponding to one of the lane line projections. Further, some such examples include an autonomy unit configured to perform autonomous lane-assist maneuvers when one of the vehicle-width projections crosses a predetermined threshold corresponding to one of the lane line projections.

In some examples, the controller is configured to generate the overlay interface further by overlaying distance-identifier projections onto the rearview image. In some such examples, the controller is configured to color-code each of the distance-identifier projections within the overlay interface to facilitate a user in identifying a distance to a nearby object.

In some examples, the controller is configured to identify a direction-of-travel of nearby vehicle based upon at least the rearview image. In some such examples, the controller is configured to color-code the nearby vehicle within the overlay interface to identify the direction-of-travel of the nearby vehicle for a user.

In some examples, the controller is configured to identify when a nearby vehicle is changing lanes based upon at least the rearview image. In some such examples, the controller is configured to color-code the nearby vehicle within the overlay interface to identify for a user that the nearby vehicle is changing lanes.

An example disclosed method includes capturing a front-view image of a road via a front-view camera and capturing a rearview image of the road via a rearview camera. The example disclosed method also includes determining, via a vehicle processor, lane line projections and vehicle-width projections based on the front-view image. The example disclosed example also includes generating an overlay interface by overlaying the lane line projections and the vehicle-width projections onto the rearview image and presenting the overlay interface via a display.

In some examples, the lane line projections of the overlay interface facilitate a user in identifying lane lines of the road via the display when the rearview image is captured in a low-light environment. In some examples, generating the overlay interface further includes overlaying color-coded distance-identifier projections onto the rearview image. In some examples, generating the overlay interface further includes color-coding a nearby vehicle to identify a direction-of-travel of the nearby vehicle for a user.

An example disclosed vehicle includes one or more cameras configured to capture at least one image and including a rearview camera configured to capture a rearview image. The example disclosed vehicle also includes a controller to determine lane line projections and vehicle-width projections based on the at least one image and generate an overlay interface by overlaying the lane line projections and the vehicle-width projections onto the rearview image. The example disclosed vehicle also includes a rearview mirror display to present the overlay interface.

In some examples, the lane line projections of the overlay interface facilitate a user in identifying lane lines of a road via the rearview mirror display when the rearview image is captured in a low-light environment. In some examples, the controller is configured to generate the overlay interface further by overlaying color-coded distance-identifier projections onto the rearview image.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example vehicle in accordance with the teachings herein.

FIG. 2 illustrates an example overlay interface presented via a rearview mirror display of the vehicle of FIG. 1 in accordance with the teachings herein.

FIG. 3 depicts an example environment in which a rearview mirror display is utilized to present an overlay interface.

FIG. 4 is a block diagram of electronic components of the vehicle of FIG. 1.

FIG. 5 is a flowchart for presenting overlay interfaces via a rearview mirror display in accordance with the teachings herein.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Generally, a vehicle includes mirrors to facilitate a driver in viewing a surrounding area of the vehicle. Oftentimes, a vehicle includes a rearview mirror that is coupled a windshield of the vehicle and facilitates a driver in viewing an area behind the vehicle. A vehicle also oftentimes includes side-view mirrors (also known as side mirrors, wing mirrors, fender mirrors) that are coupled to corresponding doors of the vehicle and facilitate a driver in viewing an area to the side of and/or behind the vehicle. Typically, each rearview and side-view mirror of a vehicle includes a reflective layer (e.g., formed of metallic material) that enables a driver to view an area to the side of and/or behind the vehicle via the mirror.

Recently, some vehicles have implemented a rearview mirror display (e.g., a liquid crystal display (LCD)) that provide image(s) and/or video captured by a vehicle camera of an area behind the vehicle. A rearview mirror display may be positioned and shaped in a manner similar to that of a traditional rearview mirror. For instance, a rearview mirror display potentially may provide a clearer image of an area behind a vehicle relative to a traditional rearview mirror as a result of providing a view of the area behind the vehicle that is not partially obstructed by a frame of the vehicle and/or objects located within a cabin of the vehicle.

In some instances, a driver potentially may find it difficult to identify objects and/or their locations relative to his or her vehicle within an image presented via a rearview mirror display. In particular, sources of bright light (e.g., headlamps, streetlamps, illuminated signs, etc.) in low-light environments (e.g., nighttime) may oversaturate portions of an image captured by a vehicle camera, thereby potentially making it difficult for the driver to identify characteristics of nearby objects within the image presented by the rearview camera display. For instance, headlamps of a trailing vehicle in a night setting potentially may make it difficult for a driver to identify in which lane the trailing vehicle is travelling.

Example methods and apparatus disclosed herein provide a technical solution to the technological problem of presenting light-saturated images via a display by presenting an interface, via a rearview mirror display and/or other display, with bright projections overlaid onto the interface to facilitate a driver in identifying objects (e.g., lane markers, other vehicles, etc.) and their relative positions in low-light environments. Examples disclosed herein include a vehicle system that includes one or more cameras (e.g., a front-view camera, a rearview camera, side-view cameras) and a rearview mirror display. The rearview mirror display presents an interface based on an image captured by a rearview camera. The system identifies lane markers of a road along which the vehicle is traveling based on images captured, for example, by a front-view camera and/or the rearview camera. The system superimposes projection(s) onto the interface presented via the rearview mirror display to facilitate a driver in identifying relative location(s) of object(s) (e.g., lane markers, other vehicles, etc.) in low-light environments (e.g., nighttime). For example, the system superimposes a projection of the lane markers onto the image presented via the rearview mirror display. The system also superimposes a projection of a width of the vehicle onto the image presented via the rearview mirror display. In some examples, the system highlights an adjacent vehicle with a selected color based on a direction of travel of the adjacent vehicle. Further, in some examples, the system identifies turn indicators of an adjacent vehicle to identify when the adjacent vehicle is changing lanes.

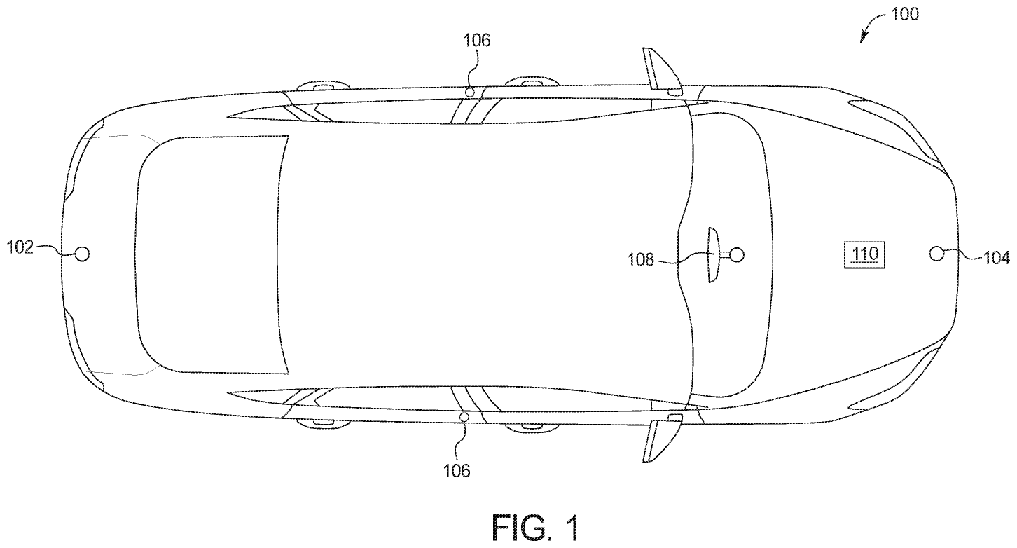

Turning to the figures, FIG. 1 illustrates an example vehicle 100 in accordance with the teachings herein. The vehicle 100 may be a standard gasoline powered vehicle, a hybrid vehicle, an electric vehicle, a fuel cell vehicle, and/or any other mobility implement type of vehicle. The vehicle 100 includes parts related to mobility, such as a powertrain with an engine, a transmission, a suspension, a driveshaft, and/or wheels, etc. The vehicle 100 may be non-autonomous, semi-autonomous (e.g., some routine motive functions controlled by the vehicle 100), or autonomous (e.g., motive functions are controlled by the vehicle 100 without direct driver input). In the illustrated example, the vehicle 100 includes a rearview camera 102, a front-view camera 104, side-view cameras 106, a rearview mirror display 108, and an interface controller 110.

The rearview camera 102 is configured to capture image(s) and/or video of an area behind the vehicle 100 (i.e., rearview image(s) and/or video). For example, the rearview camera 102 captures image(s) and/or video of a portion of a road along which the vehicle 100 is travelling. In the illustrated example, the rearview camera 102 is positioned toward a rear of the vehicle 100 to facilitate the rearview camera 102 in capturing rearview image(s) and/or video of the road behind the vehicle 100. In other examples, the rearview camera 102 may be located at any other position of the vehicle 100 that enables the rearview camera 102 to capture an unobstructed view of the area behind the vehicle 100. Further, in some examples, the rearview camera 102 is a wide-view camera that includes a wide-angle lens (e.g., having an angle-of-view of about 84 degrees) to enable the rearview camera 102 to capture a greater region of the area behind the vehicle 100 relative to a standard lens (e.g., having an angle-of-view of about 64 degrees).

The front-view camera 104 is configured to capture image(s) and/or video of an area in front of the vehicle 100 (i.e., front-view image(s) and/or video). For example, the front-view camera 104 captures image(s) and/or video of a portion of the road along which the vehicle 100 is travelling. In the illustrated example, the front-view camera 104 is positioned toward a front of the vehicle 100 to facilitate the front-view camera 104 in capturing front-view image(s) and/or video of the road in front of the vehicle 100. In other examples, the front-view camera 104 may be located at any other position of the vehicle 100 that enables the front-view camera 104 to capture an unobstructed view of the area behind the vehicle 100. Further, in some examples, the front-view camera 104 is a wide-view camera that includes a wide-angle lens to enable the front-view camera 104 to capture a greater region of the area in front of the vehicle 100 relative to a standard lens.

The side-view cameras 106 are configured to capture image(s) and/or video of areas to a side of the vehicle 100 (i.e., side-view image(s) and/or video). For example, one of the side-view cameras 106 captures image(s) and/or video of a portion of a road along a driver-side of the vehicle 100, and another of the side-view cameras 106 captures image(s) and/or video of a portion of the road along a passenger-side of the vehicle 100. In the illustrated example, the side-view cameras 106 are positioned toward respective sides of the vehicle 100 to facilitate the side-view cameras 106 in capturing side-view image(s) and/or video of the road along the sides of the vehicle 100. In other examples, the side-view cameras 106 may be located at any other positions of the vehicle 100 that enable the side-view cameras 106 to capture an unobstructed view of areas to the side of the vehicle 100. Further, in some examples, one or more of the side-view cameras 106 is a wide-view camera that includes a wide-angle lens to enable that camera to capture a greater region of the area to the side of the vehicle 100 relative to a standard lens.

The rearview mirror display 108 of the illustrated example is coupled to a windshield of the vehicle 100 and is shaped in a manner similar to that of a traditional rearview mirror. The rearview mirror display 108 is configured to present image(s) and/or video captured by the rearview camera 102. For example, the rearview mirror display 108 presents a view of the area behind the vehicle 100 to the vehicle operator that is not obstructed by a frame of the vehicle 100 and/or objects (e.g., rear-seat occupants) located within a cabin of the vehicle 100. The rearview mirror display 108 includes, for example, a liquid crystal display (LCD), an organic light emitting diode (OLED) display, a flat panel display, a solid state display, and/or any other display that is capable of presenting image(s) and/or video captured by the rearview camera 102 to occupant(s) of the vehicle 100. Further, the rearview mirror display 108 of the illustrated example includes an LCD display and/or other electronic display positioned behind a semi-transparent mirror surface (e.g., a one-way mirror) such that the semi-transparent mirror surface functions as a mirror when the electronic display is not emitting light and the electronic display emits an image and/or video through the semi-transparent mirror surface when the electronic display is emitting light.

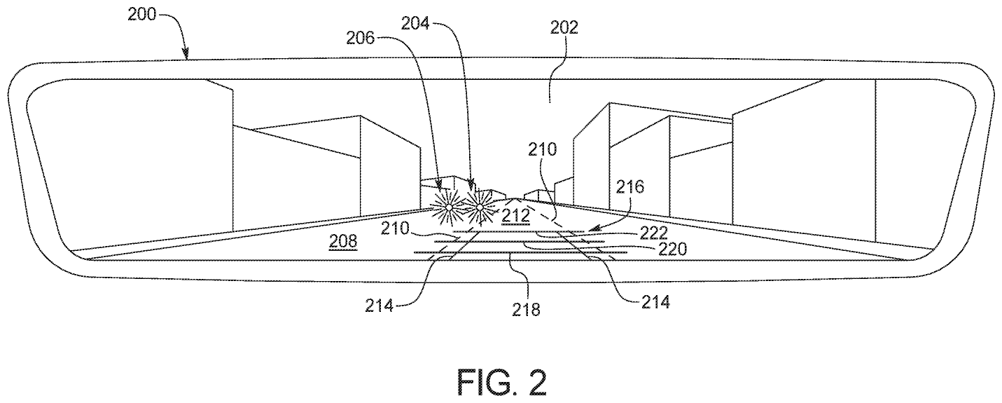

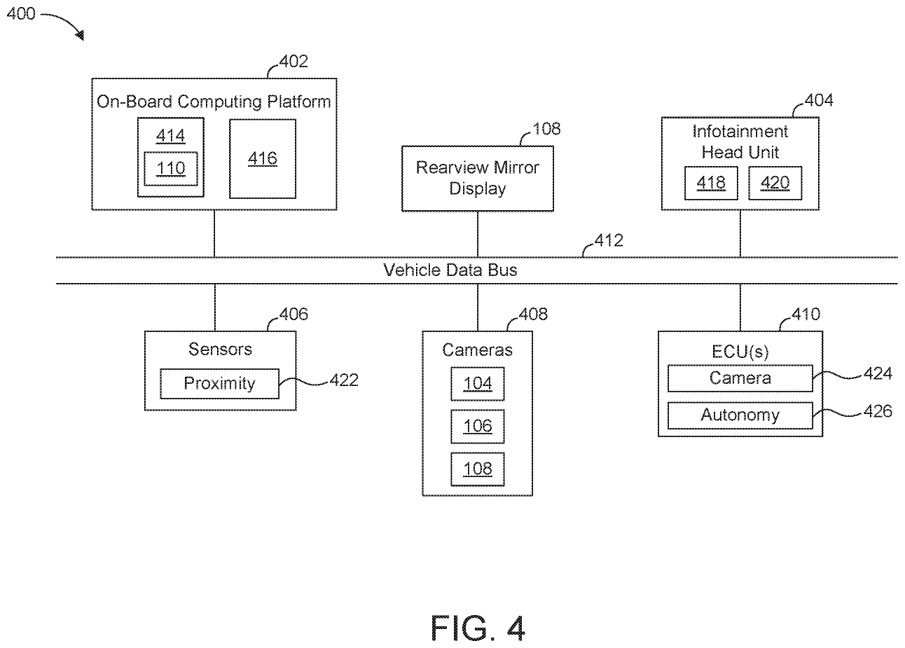

The interface controller 110 of the illustrated example generates an interface (e.g., an overlay interface 200 of FIG. 2) that is presented via the rearview mirror display 108 and/or another display of the vehicle 100 (e.g., a display 418 of FIG. 4) to facilitate the driver in identifying location(s) of object(s) behind the vehicle 100. For example, the interface controller 110 is configured to collect image(s) and/or video captured by one or more camera(s), identify object(s) within those image(s), determine projection(s) based on the characteristics of the identified object(s), and generate an overlay interface in which the projection(s) are overlaid onto an image captured by the rearview camera 102.

In the illustrated example, the interface controller 110 is configured to collect the image(s) and/or video captured by the rearview camera 102, the front-view camera 104, and/or the side-view cameras 106. For example, the interface controller 110 collects a rearview image captured by the rearview camera 102. Further, in some examples, the interface controller 110 collects a front-view image from the front-view camera 104 and/or side-view image(s) from one or more of the side-view cameras 106.

The interface controller 110 of the illustrated example also is configured to identify object(s) (e.g., lane lines, other vehicle(s), etc.) within the captured image(s) and/or video utilizing image recognition software. In some examples, the image recognition software identifies boundaries of objects within the image(s) and/or video. For example, the image recognition software identifies an object within an image by comparing the identified boundary that corresponds to the object with a database including entries that correlate object boundaries to known objects. That is, the interface controller 110 identifies an object within an image, via the image recognition software, by identifying boundaries within an image and comparing those boundaries to boundaries of known objects. Further, in some examples, the image recognition software utilized by the interface controller 110 incorporates machine learning to perform image recognition. Additionally or alternatively, the interface controller 110 utilizes data collected from one or more of proximity sensors (e.g., proximity sensors 422 of FIG. 4) to facilitate the detection, identification, and/or localization of nearby object(s). For example, the interface controller 110 utilizes data collected from proximity sensors to identify a shape and/or a relative location of an object. Additionally or alternatively, the interface controller 110 utilizes data collected from one or more of thermal cameras of the vehicle 100 to facilitate the detection, identification, and/or localization of nearby object(s). For example, the interface controller 110 utilizes data identified within image(s) captured by thermal camera(s) to identify a shape and/or a relative location of an object. Further, in some examples, the interface controller 110 utilizes data collected from image(s) captured by the thermal camera(s) to generate a hybrid overlay.

Further, the interface controller 110 of the illustrated example is configured to determine projections and/or color-coded identifiers based upon the collected images. For example, the interface controller 110 determines projections (e.g., lane line projections, vehicle-width projections, distance-identifier projections) and/or color-coded identifiers (e.g., color-coded distance-identifier projections, color-coded highlights of nearby vehicles) based upon identified characteristics of the objects within the images and/or identified characteristics of the vehicle 100.

For example, the interface controller 110 determines lane line projections (e.g., lane line projections 210 of FIG. 2) that correspond with lane lines identified in the collected images. In some examples, the interface controller 110 determines the lane line projections based upon characteristics (e.g., location, relative distance, thickness, etc.) of lane lines identified in rearview image(s) captured by the rearview camera 102. In some examples, the interface controller 110 potentially may be unable to identify characteristics of the lane lanes based on the rearview image(s) due to (i) low light levels in a low-light environment (e.g., nighttime) and/or (ii) oversaturation of bright light sources (e.g., headlamps, streetlamps, illuminated signs, etc.) in a low-light environment. In such examples, the interface controller 110 determines the lane line projections based upon characteristics of the lane lines identified in front-view image(s) captured by the front-view camera 104. For example, headlamps 112 of the vehicle 100 emit light in a manner that enables the front-view camera 104 to capture image(s) that are not over-saturated in low-light environment(s). In such examples, the interface controller 110 determines the lane line projections based on (i) the characteristics identified in the front-view image(s) and (ii) a predetermined relationship between images captured by the front-view camera 104 and the rearview camera 102. Additionally or alternatively, the interface controller 110 determines the lane line projections based upon characteristics of the lane lines identified in side-view image(s) captured by one or more of the side-view cameras 106.

The interface controller 110 of the illustrated example also determines vehicle-width projections (e.g., vehicle-width projections 214 of FIG. 2) that correspond with a width of the vehicle 100 with respect to collected rearview images. For example, the vehicle-width projections identify the width of the vehicle 100 with respect to lane lines of a lane in which the vehicle 100 is traveling. In some examples, the interface controller 110 determines the vehicle-width projections based upon characteristics of a road identified in rearview image(s) captured by the rearview camera 102. Further, in some examples, the interface controller 110 determines the vehicle-width projections based upon characteristics of the road identified in front-view image(s) captured by the front-view camera 104. Additionally or alternatively, the interface controller 110 determines the vehicle-width projections based upon characteristics of the road identified in side-view image(s) captured by one or more of the side-view cameras 106.

The interface controller 110 of FIG. 1 also is configured to determine one or more distance-identifier projections (e.g., distance-identifier projections 216 of FIG. 2) that correspond with respective distances along the road behind the vehicle 100. For example, the distance-identifier projections include horizontal lines perpendicular to a width of a lane and/or are color-coded to facilitate a driver identifying distances behind the vehicle 100. For example, a first distance-identifier projection corresponds with a first distance (e.g., 1 meter) behind the vehicle 100, a second distance-identifier projection corresponds with a second distance (e.g., 5 meters) behind the vehicle 100, and a third distance-identifier projection corresponds with a third distance (e.g., 10 meters) behind the vehicle 100. The interface controller 110 determines the distance-identifier projections based upon (i) characteristics of the vehicle 100, (ii) characteristics of the rearview camera 102 (e.g., a position of the rearview camera 102 on the body of the vehicle 100), and/or (iii) characteristics of a road identified in rearview image(s) captured by the rearview camera 102.

Further, in some examples, the interface controller 110 is configured to determines color-coded highlights of nearby vehicle(s) that correspond with a direction-of-travel of those vehicle(s). For example, the interface controller 110 highlights vehicle(s) traveling in a same direction-of-travel as the vehicle 100 with a first color (e.g., green), highlights vehicle(s) traveling in an opposite direction as the vehicle 100 with a second color (e.g., red), and highlights vehicle(s) changing lanes and/or turning behind the vehicle 100 with a third color (e.g., yellow). Additionally or alternatively, the interface controller 110 determines the color-coded highlight(s) upon identifying the direction(s)-of-travel, changing-of-lane(s), and/or turning of the nearby vehicle(s) based on the captured rearview image(s), front-view image(s), and/or side-view image(s).

After determining the projection(s) and/or color-coded highlight(s), the interface controller 110 of the illustrated example generates an overlay interface (e.g., the overlay interface 200) by overlaying the projection(s) and/or color-coded highlight(s) onto a rearview image captured by the rearview camera 102. For example, the interface controller 110 generates the overlay interface by overlaying lane line projections, vehicle-width projections, distance-identifier projections, and/or color-coded highlights onto the rearview image. Further, the rearview mirror display 108 and/or another display of the vehicle 100 presents the overlay interface to facilitate the driver in identifying the presence and/or relative location(s) of object(s) behind the vehicle (e.g., in low-light environments).

FIG. 2 illustrates an example overlay interface 200 presented via the rearview mirror display 108 of the vehicle 100. The overlay interface 200 includes bright projections and color-coded highlights that are overlaid onto a rearview image 202. In the illustrated example, the rearview image 202 of the overlay interface 200 was captured in a low-light environment (e.g., at nighttime). As illustrated in FIG. 2, the low levels of ambient light and concentrated sources of bright light oversaturate portions of the rearview image 202, thereby potentially making it difficult for the driver to identify characteristics of objects within the rearview image 202. For example, the low levels of ambient light and/or bright light 204 emitted by a trailing vehicle 206 make it difficult to identify characteristics of the trailing vehicle 206 and/or a road 208 within the rearview image 202.

The overlay interface 200 of the illustrated example includes bright projections and color-coded highlights that are overlaid onto the rearview image 202 to facilitate a driver in identifying characteristics of the road 208, the trailing vehicle 206, and/or other objects behind the vehicle 100. For example, the projections and color-coded highlights are bright to enable the driver to identify objects within the rearview image 202 that was captured in a low-light environment.

The overlay interface 200 of the illustrated example includes lane line projections 210 to facilitate the driver in identifying lane lines of the road 208 via the rearview mirror display 108. In the illustrated example, the lane line projections 210 identify a lane 212 of the road in which the vehicle 100 is traveling. In the illustrated example, the lane line projections 210 extend beyond the trailing vehicle 206 to facilitate the driver in identifying that the trailing vehicle 206 is traveling in an adjacent lane to that of the vehicle 100. Additionally or alternatively, the lane line projections 210 identify other lane(s) of the road 208 to facilitate the driver in monitoring a portion of the road 208 behind the vehicle 100. Further, the overlay interface 200 includes vehicle-width projections 214. For example, a position of the vehicle-width projections 214 relative to the lane line projections 210 facilitates the driver in identifying a position of the vehicle 100 relative to the lane 212 and/or a position of a nearby object (e.g., the trailing vehicle 206) relative to the vehicle 100.

The overlay interface 200 of the illustrated example also includes distance-identifier projections 216 that facilitate the driver in identifying a distance to a nearby object (e.g., the trailing vehicle 206). For example, the distance-identifier projections 216 includes a distance-identifier projection 218 that corresponds with a first distance behind the vehicle 100, a distance-identifier projection 220 that corresponds with a second distance behind the vehicle 100, and a distance-identifier projection 222 that corresponds with a third distance behind the vehicle 100. In some examples, the distance-identifier projections 216 are color-coded by the interface controller 110 to further facilitate the driver in distinguishing between the corresponding distances. For example, the distance-identifier projection 218 is color-coded with a first color (e.g., red), the distance-identifier projection 220 is color-coded with a second color (e.g., yellow), and the distance-identifier projection 222 is color-coded with a third color (e.g., green). Further, in the illustrated example, the vehicle-width projections 214 and the distance-identifier projections 216 are integrally formed to facilitate the vehicle-width projections 214 and the distance-identifier projections 216 in fitting within the overlay interface 200 presented via the rearview mirror display 108.

In the illustrated example, the trailing vehicle 206 is color-coded within the overlay interface 200 by the interface controller 110 to facilitate the driver in identifying a direction-of-travel of the trailing vehicle 206. For example, the trailing vehicle 206 is highlighted with a first color (e.g., green) to indicate that the trailing vehicle 206 is traveling in the same direction as the vehicle 100. In other examples, the interface controller 110 highlights a vehicle with another color (e.g., red) to indicate that the other vehicle is traveling in a direction opposite to that of the vehicle 100 and/or with yet another color (e.g., yellow, orange) to indicate that the other vehicle is turning and/or changing lanes.

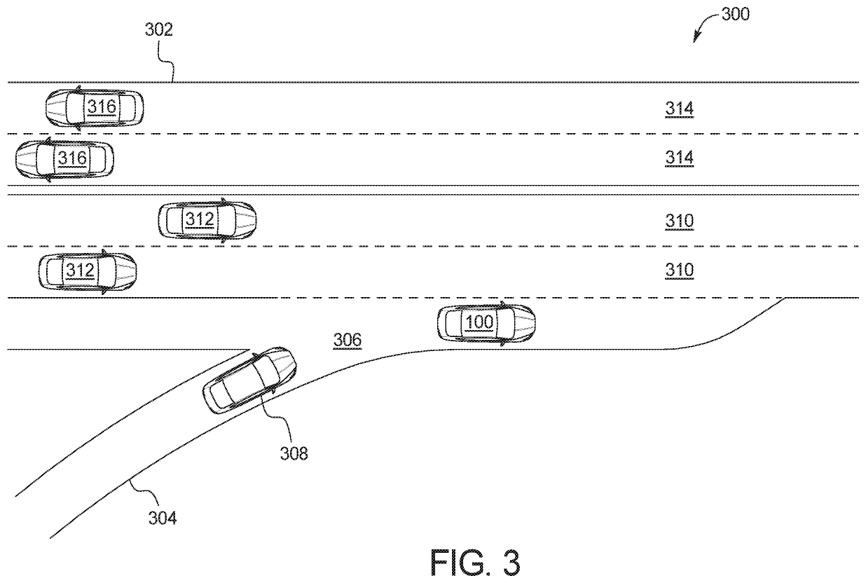

FIG. 3 depicts an example environment 300 in which the rearview mirror display 108 of the vehicle 100 is utilized. In the illustrated example, the vehicle 100 is merging onto a highway 302 via an on-ramp 304. The rearview mirror display 108 of the vehicle 100 presents an interface generated by the interface controller 110 facilitates a driver in merging the vehicle 100 onto the highway 302 (e.g., in low-light environments such as nighttime). For example, the interface generated by the interface controller 110 and presented by the rearview mirror display 108 facilitates the driver in identifying a position of the vehicle 100 with respect to (i) a merging lane 306, (ii) one or more vehicles 308 traveling behind the vehicle 100 on the on-ramp 304, (iii) one or more lanes 310 of the highway 302 for travel in the same direction as the vehicle 100, (iv) one or more vehicles 312 traveling along the lanes 310 of the highway 302 behind the vehicle 100, (v) one or more lanes 314 of the highway 302 for travel in the opposite direction as the vehicle 100, and (vi) one or more vehicles 316 traveling along the lanes 314 of the highway 302 past the vehicle 100.

FIG. 4 is a block diagram of electronic components 400 of the vehicle 100. As illustrated in FIG. 4, the electronic components 400 include an on-board computing platform 402, the rearview mirror display 108, an infotainment head unit 404, sensors 406, cameras 408, electronic control units (ECUs) 410, and a vehicle data bus 412.

The on-board computing platform 402 of the illustrated example includes a microcontroller unit, controller or processor 414 and memory 416. In some examples, the processor 414 of the on-board computing platform 402 is structured to include the interface controller 110. Alternatively, in some examples, the interface controller 110 is incorporated into another ECU with its own processor and memory. The processor 414 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 416 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, the memory 416 includes multiple kinds of memory, particularly volatile memory and non-volatile memory.

The memory 416 is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 416, the computer readable medium, and/or within the processor 414 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The infotainment head unit 404 provides interface(s) between the vehicle 100 and a user. The infotainment head unit 404 includes digital and/or analog interfaces (e.g., input devices and output devices) to receive input from and display information for the user(s). The input devices include, for example, a control knob, an instrument panel, a digital camera for image capture and/or visual command recognition, a touch screen, an audio input device (e.g., cabin microphone), buttons, or a touchpad. The output devices may include instrument cluster outputs (e.g., dials, lighting devices), actuators, a display 418 (e.g., a heads-up display, a center console display such as a liquid crystal display (LCD), an organic light emitting diode (OLED) display, a flat panel display, a solid state display, etc.), and/or speakers 420. For example, the display 418 is configured to present the overlay interface 200 to the driver. Further, the display 418 and/or the speakers 420 are configured to emit a lane-departure warning when one of the vehicle-width projections 214 crosses a predetermined threshold corresponding to one of the lane line projections 210 (e.g., to alert the driver that the vehicle 100 is drifting into another lane). In the illustrated example, the infotainment head unit 404 includes hardware (e.g., a processor or controller, memory, storage, etc.) and software (e.g., an operating system, etc.) for an infotainment system (e.g., SYNC® and MyFord Touch® by Ford®). Additionally, the infotainment head unit 404 displays the infotainment system on, for example, the display 418.

The sensors 406 are arranged in and/or around the vehicle 100 to monitor properties of the vehicle 100 and/or an environment in which the vehicle 100 is located. One or more of the sensors 406 may be mounted to measure properties around an exterior of the vehicle 100. Additionally or alternatively, one or more of the sensors 406 may be mounted inside a cabin of the vehicle 100 or in a body of the vehicle 100 (e.g., an engine compartment, wheel wells, etc.) to measure properties in an interior of the vehicle 100. For example, the sensors 406 include accelerometers, odometers, tachometers, pitch and yaw sensors, wheel speed sensors, microphones, tire pressure sensors, biometric sensors and/or sensors of any other suitable type. In the illustrated example, the sensors 406 include one or more proximity sensors 422 that are configured to facilitate in the detection, location, and/or identification of object(s) near the vehicle 100. The proximity sensors 422 include radar sensor(s), lidar sensor(s), ultrasonic sensor(s), and/or any other sensor that is configured to collect data utilized to detect, utilize, and/or identify a nearby object. For example, a radar sensor detects and locates an object via radio waves, a lidar sensor detects and locates an object via lasers, and an ultrasonic sensor detects and locates the object via ultrasound waves.

The cameras 408 are arranged in and/or around the vehicle 100 to monitor an environment in which the vehicle 100 is located and/or an environment within a cabin of the vehicle 100. For example, the cameras 408 capture image(s) and/or video of a surrounding area of the vehicle 100 to facilitate the interface controller 110 in generating an interface (e.g., the overlay interface 200 of FIG. 2) for the rearview mirror display 108 and/or to facilitate the vehicle 100 in performing autonomous motive functions. In the illustrated example, the cameras 408 include the rearview camera 102, the front-view camera 104, and the side-view cameras 106.

The ECUs 410 monitor and control the subsystems of the vehicle 100. For example, the ECUs 410 are discrete sets of electronics that include their own circuit(s) (e.g., integrated circuits, microprocessors, memory, storage, etc.) and firmware, sensors, actuators, and/or mounting hardware. The ECUs 410 communicate and exchange information via a vehicle data bus (e.g., the vehicle data bus 412). Additionally, the ECUs 410 may communicate properties (e.g., status of the ECUs 410, sensor readings, control state, error and diagnostic codes, etc.) to and/or receive requests from each other. For example, the vehicle 100 may have dozens of the ECUs 410 that are positioned in various locations around the vehicle 100 and are communicatively coupled by the vehicle data bus 412.

In the illustrated example, the ECUs 410 include a camera module 424 and an autonomy unit 426. The camera module 424 controls one or more of the cameras 408 to collect image(s) and/or video that are presented to occupant(s) of the vehicle 100 via a display (e.g., the rearview mirror display 108), utilized by the interface controller 110 to generate an overlay interface (e.g., the overlay interface 200) and/or utilized by the autonomy unit 426 to perform autonomous and/or semi-autonomous driving maneuvers for the vehicle 100. The autonomy unit 426 controls performance of autonomous and/or semi-autonomous driving maneuvers of the vehicle 100 based upon, at least in part, image(s) and/or video captured by the cameras 408 and/or data collected by the proximity sensors 422. For example, the autonomy unit 426 is configured to perform autonomous lane-assist maneuvers when one of the vehicle-width projections 214 crosses a predetermined threshold corresponding to one of the lane line projections 210 (e.g., to keep the vehicle 100 completely within a particular lane).

The vehicle data bus 412 communicatively couples the rearview mirror display 108, the on-board computing platform 402, the infotainment head unit 404, the sensors 406, the cameras 408, and the ECUs 410. In some examples, the vehicle data bus 412 includes one or more data buses. The vehicle data bus 412 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

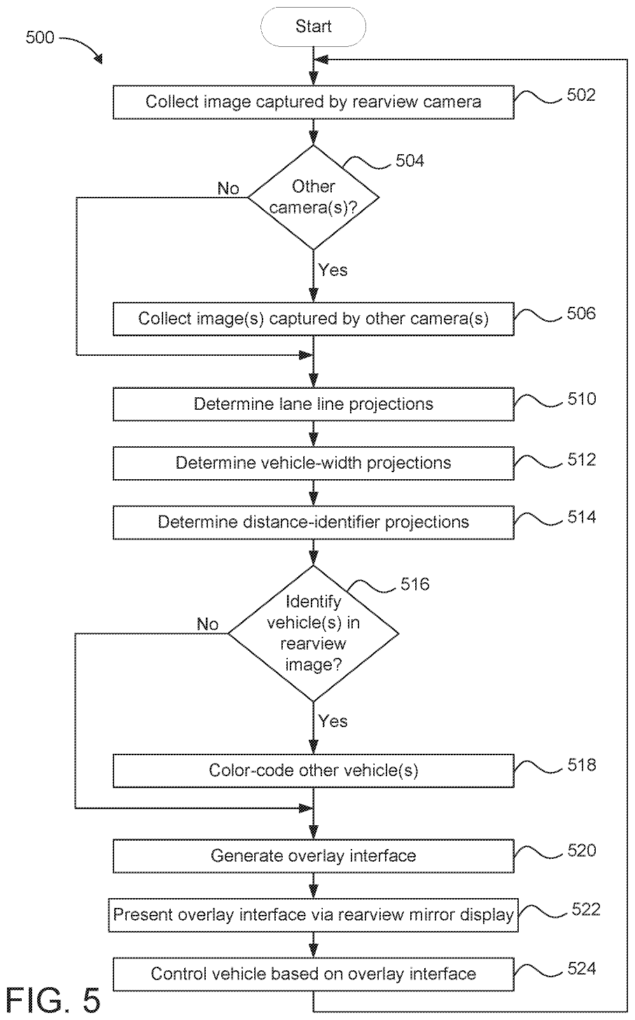

FIG. 5 is a flowchart of an example method 500 to present an overlay interface via a rearview mirror display. The flowchart of FIG. 5 is representative of machine readable instructions that are stored in memory (such as the memory 416 of FIG. 4) and include one or more programs which, when executed by a processor (such as the processor 414 of FIG. 4), cause the vehicle 100 to implement the example interface controller 110 of FIGS. 1 and 4. While the example program is described with reference to the flowchart illustrated in FIG. 5, many other methods of implementing the example interface controller 110 may alternatively be used. For example, the order of execution of the blocks may be rearranged, changed, eliminated, and/or combined to perform the method 500. Further, because the method 500 is disclosed in connection with the components of FIGS. 1-5, some functions of those components will not be described in detail below.

Initially, at block 502, the interface controller 110 collects a rearview image of a road along which the vehicle 100 is travelling that is captured the rearview camera 102. At block 504, the interface controller 110 determines whether there are other camera(s) of the vehicle 100 that are capturing image(s) of the road along which the vehicle 100 is travelling. In response to the interface controller 110 determining that there are other camera(s), the method 500 proceeds to block 506 at which the interface controller 110 collects the image(s) captured by the other camera(s) (e.g., the front-view camera 104, the side-view cameras 106, other one(s) of the cameras 408). Otherwise, in response to the interface controller 110 determining that there is no other camera, the method 500 proceeds to block 508 without performing block 506.

At block 508, the interface controller 110 determines lane line projections (e.g., the lane line projections 210 of FIG. 2) for an overlay interface (e.g., the overlay interface 200 of FIG. 2) based upon the captured image(s). At block 510, the interface controller 110 determines vehicle-width projections (e.g., the vehicle-width projections 214 of FIG. 2) for the overlay interface based upon the captured image(s). At block 512, the interface controller 110 determines distance-identifier projections (e.g., the lane line projections 210 of FIG. 2) for the overlay interface based upon the captured image(s). For example, the interface controller 110 utilizes image-recognition software to determine the lane line projections, the vehicle-width projections, and the distance-identifier projections based upon the captured image(s).

At block 514, the interface controller 110 determines whether any vehicle(s) (e.g., the trailing vehicle 206 of FIG. 2) were identified in the image captured by the rearview camera 102. For example, the interface controller 110 utilizes image-recognition software to identify vehicle(s) within the captured rearview image. In response to the interface controller 110 identifying vehicle(s) within the rearview image, the method 500 proceeds to block 516 at which the interface controller 110 color-codes the vehicle(s) identified within the rearview image based on a respective direction-of-travel. For example, upon identifying a vehicle within the rearview image, the interface controller 110 determines a direction-of-travel of the identified vehicle relative to that of the vehicle 100 and color-codes the identified vehicle based on its direction-of-travel. Otherwise, in response to the interface controller 110 not identifying a vehicle within the rearview image, the method 500 proceeds to block 518 without performing block 516.

At block 518, the interface controller 110 generates an overlay interface (e.g., the overlay interface 200). For example, the interface controller 110 generates the overlay interface by overlaying the lane line projections, the vehicle-width projections, the distance-identifier projections, color code(s) of identified vehicle(s), and/or other projection(s) and/or color code(s) determined by the interface controller 110 onto the rearview image captured by the rearview camera 102. At block 520, the rearview mirror display 108 presents the overlay interface generated by the interface controller 110. Further, at block 522, the interface controller 110 controls the vehicle 100 based upon the overlay interface. For example, the interface controller 110 emits a lane-departure warning and/or causes the autonomy unit 426 to perform autonomous lane-assist maneuvers in response to determining, based upon the overlay interface, that the vehicle 100 is leaving its lane.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively. Additionally, as used herein, the terms “module” and “unit” refer to hardware with circuitry to provide communication, control and/or monitoring capabilities. A “module” and a “unit” may also include firmware that executes on the circuitry.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
a front-view camera to capture a front-view image;
a rearview camera to capture a rearview image;
a controller configured to:
determine lane line projections and vehicle-width projections based on the front-view image; and
generate an overlay interface by overlaying the lane line projections and the vehicle-width projections onto the rearview image; and
a rearview mirror display to present the overlay interface.

2. The vehicle of claim 1, wherein the controller is configured to determine the lane line projections and the vehicle-width projections further based on the rearview image.

3. The vehicle of claim 2, further including side-view cameras configured to capture side-view images, wherein the controller is configured to determine the lane line projections and the vehicle-width projections further based on the side-view images.

4. The vehicle of claim 1, wherein the lane line projections of the overlay interface facilitate a user in identifying lane lines of a road via the rearview mirror display when the rearview image is captured in a low-light environment.

5. The vehicle of claim 4, wherein a position of the vehicle-width projections relative to the lane line projections facilitates the user in identifying a relative location of a nearby object.

6. The vehicle of claim 5, wherein the controller is configured to emit a lane-departure warning when one of the vehicle-width projections crosses a predetermined threshold corresponding to one of the lane line projections.

7. The vehicle of claim 5, further including an autonomy unit configured to perform autonomous lane-assist maneuvers when one of the vehicle-width projections crosses a predetermined threshold corresponding to one of the lane line projections.

8. The vehicle of claim 1, wherein the controller is configured to generate the overlay interface further by overlaying distance-identifier projections onto the rearview image.

9. The vehicle of claim 8, wherein the controller is configured to color-code each of the distance-identifier projections within the overlay interface to facilitate a user in identifying a distance to a nearby object.

10. The vehicle of claim 1, wherein the controller is configured to identify a direction-of-travel of nearby vehicle based upon at least the rearview image.

11. The vehicle of claim 10, wherein the controller is configured to color-code the nearby vehicle within the overlay interface to identify the direction-of-travel of the nearby vehicle for a user.

12. The vehicle of claim 1, wherein the controller is configured to identify when a nearby vehicle is changing lanes based upon at least the rearview image.

13. The vehicle of claim 12, wherein the controller is configured to color-code the nearby vehicle within the overlay interface to identify for a user that the nearby vehicle is changing lanes.

14. A method comprising:
capturing a front-view image of a road via a front-view camera;
capturing a rearview image of the road via a rearview camera;
determining, via a vehicle processor, lane line projections and vehicle-width projections based on the front-view image;
generating an overlay interface by overlaying the lane line projections and the vehicle-width projections onto the rearview image; and
presenting the overlay interface via a display.

15. The method of claim 14, wherein the lane line projections of the overlay interface facilitate a user in identifying lane lines of the road via the display when the rearview image is captured in a low-light environment.

16. The method of claim 14, wherein generating the overlay interface further includes overlaying color-coded distance-identifier projections onto the rearview image.

17. The method of claim 14, wherein generating the overlay interface further includes color-coding a nearby vehicle to identify a direction-of-travel of the nearby vehicle for a user.

18. A vehicle comprising:
one or more cameras configured to capture at least one image and including a rearview camera configured to capture a rearview image;
a controller to:
determine lane line projections and vehicle-width projections based on the at least one image; and
generate an overlay interface by overlaying the lane line projections and the vehicle-width projections onto the rearview image; and
a rearview mirror display to present the overlay interface.

19. The vehicle of claim 18, wherein the lane line projections of the overlay interface facilitate a user in identifying lane lines of a road via the rearview mirror display when the rearview image is captured in a low-light environment.

20. The vehicle of claim 18, wherein the controller is configured to generate the overlay interface further by overlaying color-coded distance-identifier projections onto the rearview image.
